(19) United States
(12) Patent Application Publication
(10) Pub. No.: US 2026/0356067 A1
(43) Pub. Date: Nov. 12, 2026

(54) SYSTEM AND METHOD FOR COFFEE POD CORRECTING

(71) Applicant: Matthew Auld, Wakefield, MA (US)

(72) Inventor: Matthew Auld, Wakefield, MA (US)

(21) Appl. No.: 19/669,201

(22) Filed: May 6, 2026

Related U.S. Application Data
(60) Provisional application No. 63/801,210, filed on May 7, 2025.

(51) Int. Cl. B30B 3/02; A47J 31/44

(52) U.S. Cl. CPC B30B 3/02; A47J 31/44

(57) ABSTRACT

The present disclosure pertains to a system and method of correcting a coffee pod including a top component with a first concave cavity within a first body, a first distal end, and a top thick rim around the first distal end. Additionally, the system and method of correcting a coffee pod includes a base with a plurality of legs, a second concave cavity within a second body, a second distal end, and a bottom thick rim around the second distal end.

### CROSS REFERENCE TO RELATED APPLICATION

This application claims the benefit of U.S. Provisional Patent Application Ser. No. 63/801,210 filed May 7, 2025. The related application is incorporated herein in its entirety by reference.

### FIELD OF THE INVENTION

This invention relates generally to a coffee pod correcting system and method, and more particularly to a system and method utilized to flatten rims of commercial coffee pods, in order to prevent commercial coffee pods from jamming a coffee machine, configured to brew commercial coffee pods.

### BACKGROUND OF THE INVENTION

Coffee pods were invented in 1986 by a Swiss multinational company. While coffee pods have developed throughout the years, 2018 saw 59 billion coffee pods produced. With the surge of popularity, the coffee pod industry was valued at around $1.3 billion.

Since then, many companies have created and developed enhancements and variations of the original coffee pod. Specifically, commercial coffee machines and pods were produced for office environments, where many users reaped the benefits of having a coffee machine capable of brewing individual cups of coffee.

Furthermore, commercial coffee pods were developed, with intensions of being utilized in office environments. Commercial coffee pods possess a separate overall shape, compared to original/personal and home-use coffee pods. For instance, commercial coffee pods resemble a saucer, with an enclosed capsule in the middle, surrounded by an edged rim. These specific pods were created for several reasons. For instance, an office setting usually holds more individuals than a household environment. Therefore, more coffee is needed. The saucer-like commercial coffee pod was developed for ease of transportation because more pods could be shipped in bulk amounts, compared to the bulkier design of the home-use coffee pod. Also, commercial coffee pods are airtight, resulting in a coffee pod that can preserve fresh coffee for extended periods of time.

However, along with new coffee pods came new coffee machines. Commercial coffee machines were developed to accommodate and house the new commercial coffee pods. Yet, the new shape of the commercial coffee pods poses issues for office environments when the outer rim of the saucer-like coffee pod becomes bent and does not operate properly inside of the commercial coffee pod machine. As a result, technicians are constantly summoned to travel to various office locations and service commercial coffee machines, in order for users to continue to reap the rewards of their liquid caffeine. Moreover, technicians are expensive, retroactive, and time-consuming. What is missing is a system and method that can be utilized in place of requesting and waiting for technicians to fix the machine issues, in order to avoid the consistent jamming and malfunctioning of commercial coffee machines. The instant application discloses a cheap, fast, and proactive solution that provides a system and method, utilized by a user, with desired results.

### SUMMARY OF THE INVENTION

The instant system and method, as illustrated herein, is clearly not anticipated, rendered obvious, or even present in any of concurrent mechanisms, either alone or in any combination thereof. Thus, the several embodiments of the instant system and method are illustrated herein.

The primary objective of the instant disclosure is to provide a system and method for correcting coffee pods that provide a proactive solution to bent, dented, and warped commercial coffee pods, in order to prevent jamming and malfunctioning of commercial coffee pod machines.

Another object of the instant disclosure is to provide a fast technique that is to be utilized in place of waiting for a commercial coffee pod machine to malfunction and having to call a technician to fix the machine.

Another object of the instant disclosure is to provide a cheap, alternative system and method compared to the process of requesting a technician and paying for services rendered at the completion of their tasks.

The coffee pod correcting system preferably comprises a base and a top component. Both the base and the top component comprise concave cavities that are configured to accommodate a commercial coffee pod. Furthermore, the base and the top component each further comprise a thick rim around the circumference of each component. This provides an extended surface area for the top component to rest on top of the base without the threat of impending collapse. Furthermore, the cavity and the thick rim allow the encapsulated area of the commercial coffee pod to sit within the cavity of the coffee pod correcting system, specifically in between the top component and the base, while the rim of the commercial coffee pod is wedged in between the thick rim of the base and the thick rim of the top component. Finally, the top component and the base can be forcefully pressed together and rotated in alternate directions, utilizing friction and applied force to flatten and smooth a rim of a commercial coffee pod.

In addition to its use, the coffee pod correcting system is preferably made from wood. However, in alternative embodiments, the coffee pod correcting system is made from, and not limited to, plastic, silicon, rubber, aluminum, steel, carbon fiber, composite, glass, titanium, ceramic, paper, concrete, leather, stone, bronze, silver, gold, copper, rope, etc.

In some embodiments, the coffee pod correcting system comprises legs that serve as a stability component to a base of the system. As a result, the coffee pod correcting system can be utilized without the use of both hands.

In some embodiments, the coffee pod correcting system comprises suction cups and/or gripping pads on the bottom of the legs, in order to increase stability while the coffee pod correcting system is being used.

In another embodiment, the coffee pod correcting system comprises a handle that allows users to continuously rotate a top portion of the system with ease.

In an additional embodiment, the coffee pod correcting system comprises a storage component that attaches to the base in a ring-like-tray fashion. As a result, after bent, dented, and/or warped coffee pods are corrected by utilizing the instant system and method to flatten the rim of the pods, the pods can be placed in a plurality of cup rings in the storage tray that protects the pods from being re-bent and stores them in an accessible area that increases ease of usage.

In yet another embodiment, the coffee pod correcting system comprises a manual spring subsystem. A spring is attached to a middle top of the top component and the underside of a knob. From there, the knob can be wound and released, resulting in the top component spinning over the bottom component, flattening the rim of a commercial coffee pod. As a result, the coffee pod correcting system becomes semi-automatic.

In another embodiment, the base and the top component comprise a reduced cavity, giving the coffee pod correcting system the appearance of a hockey puck. However, the coffee pod correcting system is utilized in the same fashion as the former embodiments, discussed above.

There has thus been outlined, rather broadly, the more important features of the coffee pod correcting system and method. In order for the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description, and/or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

The invention may be more completely understood in consideration of the following detailed description of various embodiments of the invention in connection with the accompanying drawings, in which:

FIG. 1A is a perspective view of one embodiment of the coffee pod correcting system.

FIG. 1B is a perspective view of a top component of the coffee pod correcting system.

FIG. 1C is a perspective view of an alternate embodiment of the top component of the coffee pod correcting system.

FIG. 1D is a perspective view of a base of the coffee pod correcting system.

FIG. 1E is a perspective view of the base of the coffee pod correcting system with a commercial coffee pod residing in the base.

FIG. 1F is a bottom view of the base of the coffee pod correcting system with a plurality of legs at the bottom of the base.

FIG. 1G is a bottom view of an embodiment of the base of the coffee pod correcting system with a plurality of suction cups on the bottom of the plurality of legs.

FIG. 1H is a bottom view of an embodiment of the base of the coffee pod correcting system with a plurality of grip pads on the bottom of the plurality of legs.

FIG. 2 illustrates a flow diagram of a method for correcting a commercial coffee pod.

FIG. 3A is a perspective view of an alternate base of the coffee pod correcting system.

FIG. 3B is a perspective view of an alternate top component of the coffee pod correcting system.

FIG. 4A illustrates a perspective view of another alternate top component of the coffee pod correcting system.

FIG. 4B illustrates a perspective view of another alternate base of the coffee pod correcting system.

FIG. 4C illustrates a perspective view of another alternate embodiment of the top component of the coffee pod correcting system.

FIG. 5 illustrates a perspective view of an embodiment of the base of the coffee pod correcting system with a storage tray.

### DETAILED DESCRIPTION OF THE SEVERAL EMBODIMENTS

The detailed description set forth below in connection with the appended drawings is intended as a description of several embodiments of the apparatus and does not represent the only forms in which the present apparatus may be constructed and/or utilized. The description sets forth the functions and the sequence of steps for constructing and operating the apparatus in connection with the illustrated embodiments. However, it is to be understood that the same or equivalent functions and sequences may be accomplished by different embodiments that are also intended to be encompassed within the spirit and scope of the invention.

For the following defined terms, these definitions shall be applied, unless a different definition is given in the claims or elsewhere in this specification. All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate respective like elements throughout the several views. The drawings, which are not necessarily to scale, depict illustrative embodiments of the claimed invention.

Reference will now be made to non-limiting embodiments, examples of which are illustrated in the Figures.

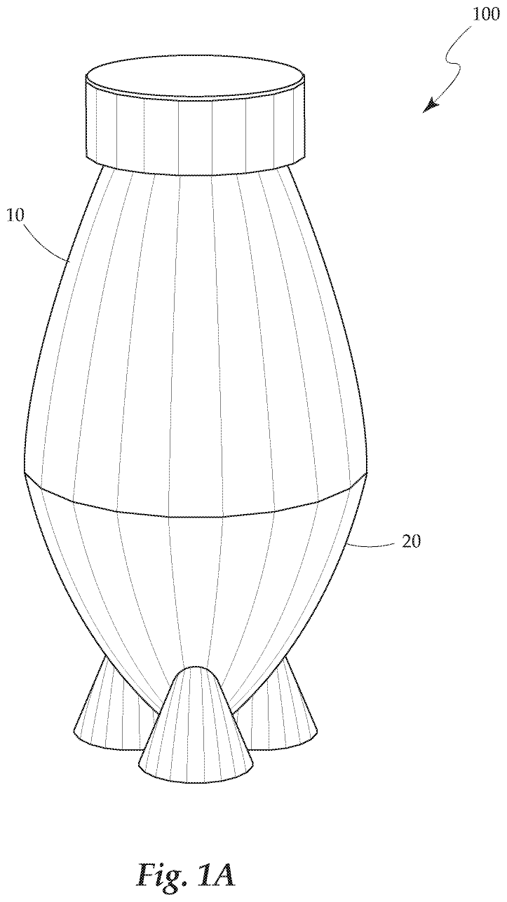

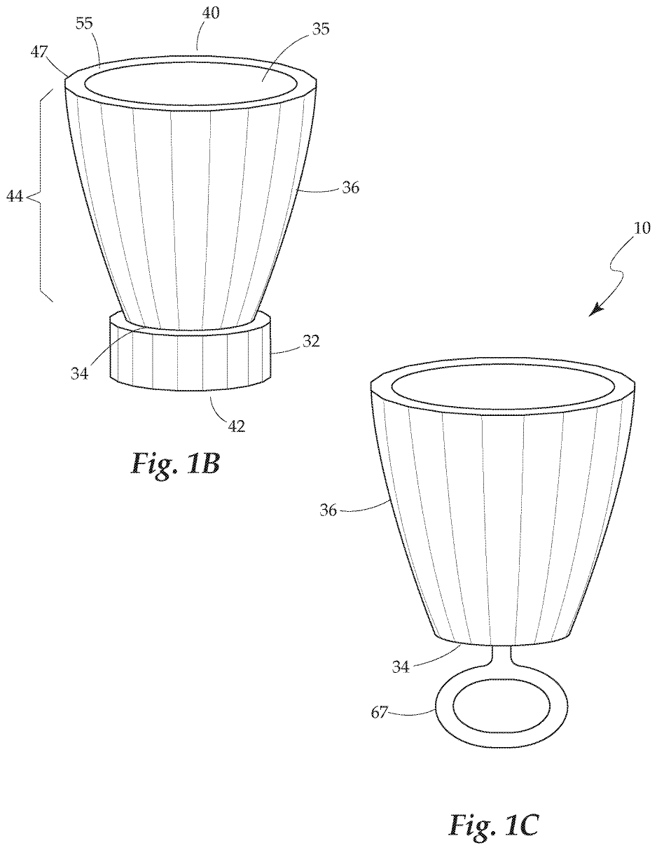

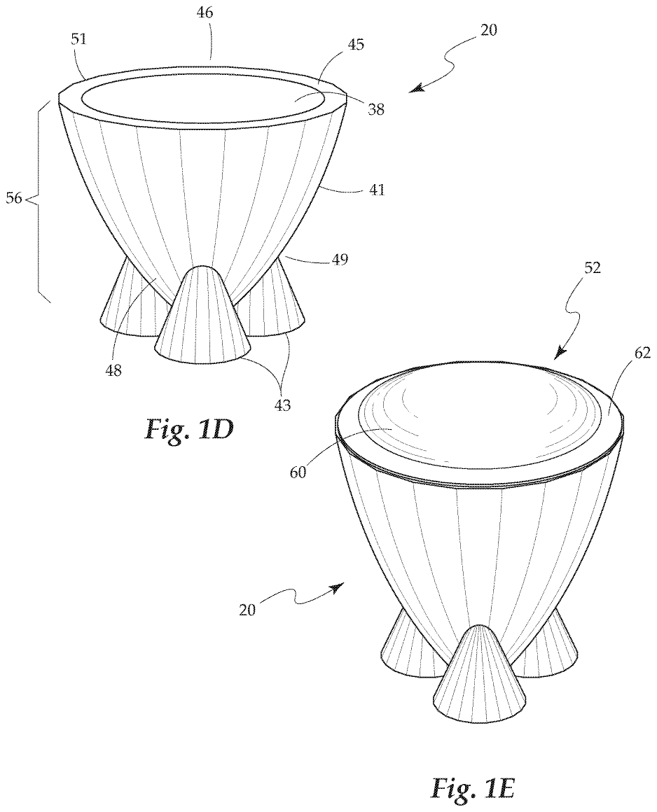

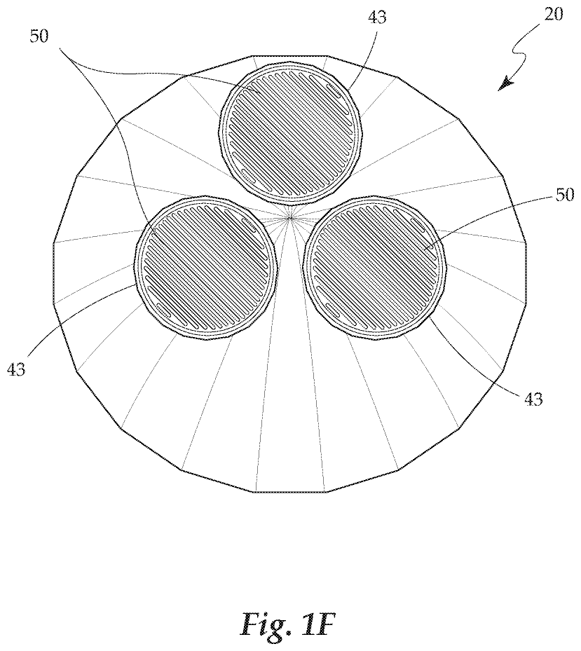

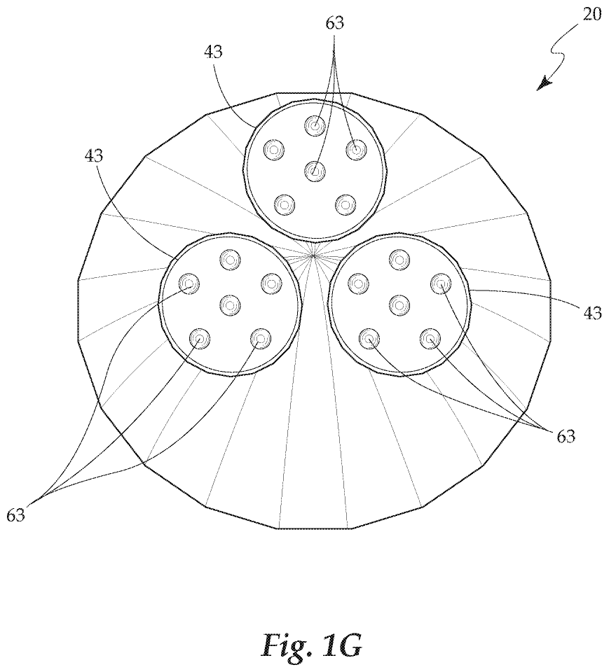

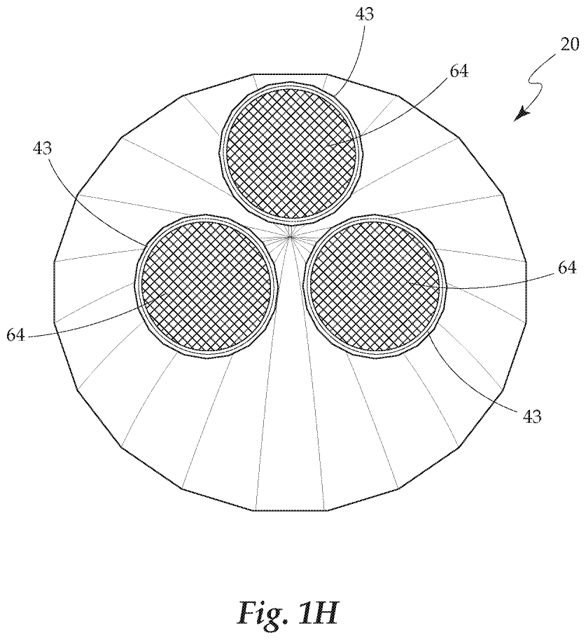

FIG. 1A illustrates a perspective view of a coffee pod correcting system 100. Specifically, the coffee pod correcting system 100 comprises a top component 10 and a base 20. Furthermore, FIG. 1B illustrates the top component 10, wherein the top component further comprises a first body 36 with a top thick rim 55, a first outer rim 47, a knob 32, and a top center area 34. Specifically, the first body 36 provides surface area for a user's hand to grasp onto in order to efficiently utilize the coffee pod correcting system 100. In a preferred embodiment, the first body 36 resembles a cone-like shape where a first distal end 40 is most distal from the top center area 34 and possesses a widest point of the top component 10. Moreover, a first proximal end 42 is proximal to the top center area 34 and is the end point of a first gradually narrowing circumference 44 of the first body 36, starting at the first distal end 40. Also, the first body 36 includes a first concave cavity 35 that allows a commercial coffee pod 52 to be inserted into the coffee pod correcting system 100 (see FIG. 1E). In some embodiments, the first concave cavity 35 expands throughout all of the first body 36. In other words, the first body 36 is hollow, to accommodate all sizes of commercial coffee pods. In a preferred embodiment, the first concave cavity 35 is the depth and shape of one half of the commercial coffee pod 52, when the commercial coffee pod 52 is cut, latitudinally. Therefore, the first concave cavity 35 provides a snug fitting and prevents wobbling and damage to the commercial coffee pod 52 when the coffee pod correcting system 100 is in use.

Additionally, the knob 32 is fastened to the top center area 34. In a preferred embodiment, the knob 32 is fastened via shaping of excess material attached to the first body 36. In an alternate embodiment, the knob 32 is fastened via, but not limited to, glue, welding, a screw, etc. In some embodiments, the knob 32 is shaped in a saucer-like fashion with a latitudinal middle possessing a largest diameter. In a preferred embodiment, the knob 32 is shaped in a cylindrical fashion with its diameter greater than its height. Moreover, the knob 32 resides on top of the first body 36 to provide an alternate gripping element when a user is utilizing the coffee pod correcting system 100.

FIG. 1C illustrates a perspective view of an alternate embodiment of the top component 10. As shown in FIG. 1C, the top component 10 can include a handle 67 fastened to the top center area 34. The handle 67 can allow users to continuously rotate the top component 10 with ease. The handle 67 can similarly be fastened to the top center area 34 via, but not limited to, glue, welding, a screw, etc.

FIG. 1D illustrates a perspective view of the base 20 of the coffee pod correcting system 100. Specifically, the base 20 further comprises a plurality of legs 43, a second body 41, a bottom thick rim 45, and a second outer rim 51. Furthermore, the plurality of legs 43 are fastened to a bottom center area 48 of the second body 41. In a preferred embodiment, the first body 36 is the same height, length, width, and depth of the second body 41. Also, in a preferred embodiment, the plurality of legs 43 are fastened via shaping of excess material attached to the second body 41. In an alternate embodiment, the plurality of legs 43 are fastened via, but not limited to, glue, welding, screws, etc. The plurality of legs 43 are cone shaped, with a plurality of bottoms 50 (see FIG. 1F), and extend downwardly from the bottom center area 48 to support the base 20 in an upright fashion.

Furthermore, in a preferred embodiment, the second body 41 resembles a cone-like shape where a second distal end 46 is most distal from the bottom center area 48 and possesses a widest point. A second proximal end 49 is proximal to the bottom center area 48 and is an end point of a second gradually narrowing circumference 56 of the second body 41, starting from the second distal end 46. Also, the second body 41 includes a second concave cavity 38 that allows a commercial coffee pod 52 to be inserted into the coffee pod correcting system (see FIG. 1E). In some embodiments, the second concave cavity 38 expands throughout the second body 41. In other words, the second body 41 is also hollow, to accommodate all sizes of commercial coffee pods. In a preferred embodiment, the second concave cavity 38 is the size of one half of the commercial coffee pod 52, when the commercial coffee pod 52 is cut, latitudinally. Therefore, the second concave cavity 38 provides a snug fitting and prevents wobbling and damage to the commercial coffee pod 52 when the coffee pod correcting system 100 is in use.

FIG. 1E illustrates a perspective view of the base 20 of the coffee pod correcting system 100. Specifically, FIG. 1E shows the commercial coffee pod 52 resting within the second concave cavity 38 and on top of the bottom thick rim 45 of the base 20. Furthermore, the commercial coffee pod 52 further comprises a rimmed edge 62 and a capsule 60 that sits inside of the rimmed edge 62 and houses ground coffee beans. The rimmed edge 62 rests on top of the bottom thick rim 45 of the base 20. Therefore, the bottom thick rim 45 is wide enough to accommodate an entire width of the rimmed edge 62. As a result, all of the rimmed edge 62 rests on the bottom thick rim 45, resulting in no overhang of the commercial coffee pod 52. Additionally, the capsule 60 rests within the second concave cavity 38. Moreover, the bottom thick rim 45 resides at the second distal end 46.

Ultimately the coffee pod correcting system 100 flattens the rimmed edge 62 of the commercial coffee pod 52 when the bottom thick rim 45 of the base 20 and the top thick rim 55 of the top component 10 come together with the rimmed edge 62 resting in between the bottom thick rim 45 and the top thick rim 55. Furthermore, the capsule 60 resides in between the first concave cavity 35 and the second concave cavity 38, during use. From there, a user produces applied force between the top component 10 and the base 20. At the same time, a user repeatedly twists the top component 10 in an opposite direction of a direction of the base 20. As a result, the rimmed edge 62 flattens, resolving the issues of any bends, bumps, or dents that the commercial coffee pod 52 may have previously acquired.

FIG. 1F illustrates the plurality of legs 43 with the plurality of bottoms 50 support the base 20 in an upright fashion. As shown in FIG. 1G, in some embodiments, the plurality of bottoms 50 further comprise a plurality of suction cups 63 for attaching to a surface, providing increased stability, and preventing sliding when the coffee pod correcting system 100 is in use. The plurality of suction cups 63 can vary in size and number across the plurality of bottoms 50. As shown in FIG. 1H, in some embodiments, the plurality of bottoms 50 comprise a plurality of grip pads 64 for increased stability and sliding prevention when the coffee pod correcting system 100 is in use. The plurality of grip pads 64 can be made of, but not limited to, rubber, silicone, plastic, felt, other textured materials to prevent the coffee pod correcting system 100 from sliding when in use. In some embodiments, the plurality of bottoms 50 can comprise both the plurality of suction cups 63 and the plurality of grip pads 64.

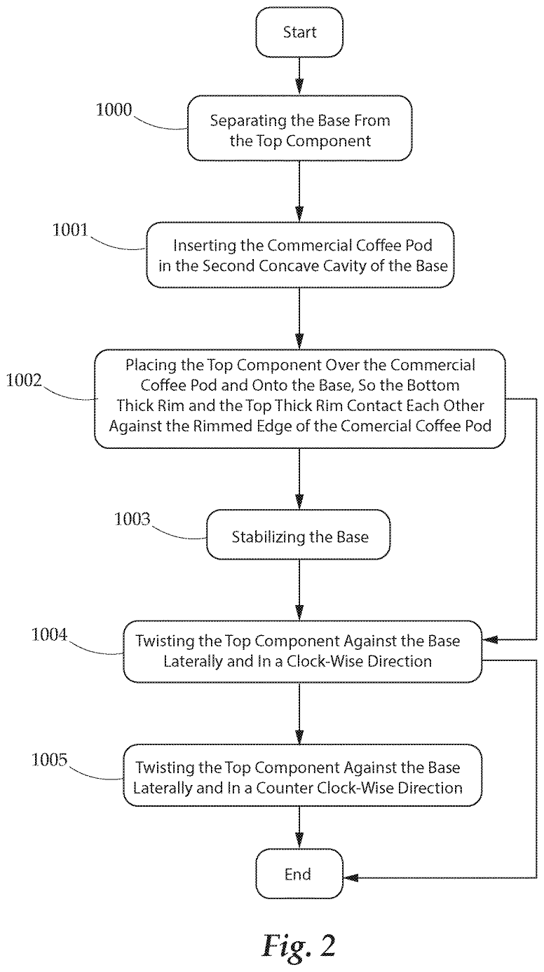

FIG. 2 illustrates the method for correcting a commercial coffee pod utilizing the coffee pod correcting system 100. Specifically, the method begins with separating the base 20 from the top component 10, as step 1000. After, the coffee pod correcting system 100 requires step 1001 comprised of inserting the commercial coffee pod 52 in the second concave cavity 38 of the base 20. Sequentially, the method continues with step 1002 by placing the top component 10 over the commercial coffee pod 52 and onto the base 20, so the bottom thick rim 45 and the top thick rim 55 contact each other against the rimmed edge 62 of the commercial coffee pod 52. The former step is followed by the optional step 1003 of stabilizing the base 20. The following step 1004 includes twisting the top component 10 against the base 20, laterally and in a clock-wise direction. Furthermore, another optional step 1005 includes twisting the top component against the base laterally and in a counter clock-wise direction.

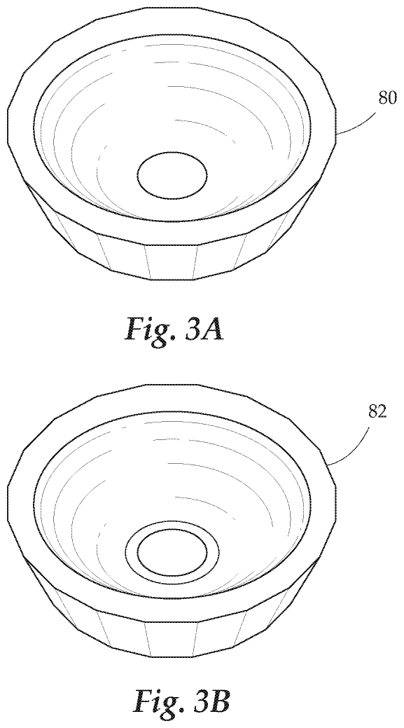

FIGS. 3A and 3B illustrate a perspective view of an alternate embodiment of the coffee pod correcting system 100. Specifically, in FIG. 3A, an alternate base 80 is shown without the cone-shaped body of the preferred embodiment, described earlier. In FIG. 3B, an alternate top component 82 is shown without the cone-shaped body of the preferred embodiment, described earlier. This smaller design allows the coffee pod correcting system to be more portable and easier to store in smaller spaces while producing the same flattened rimmed edge 62 of the commercial coffee pod 52.

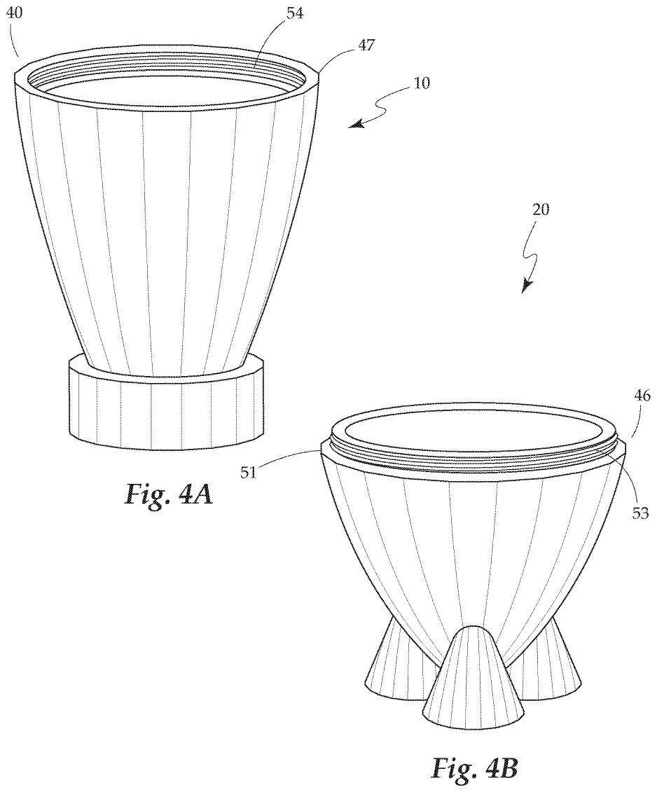

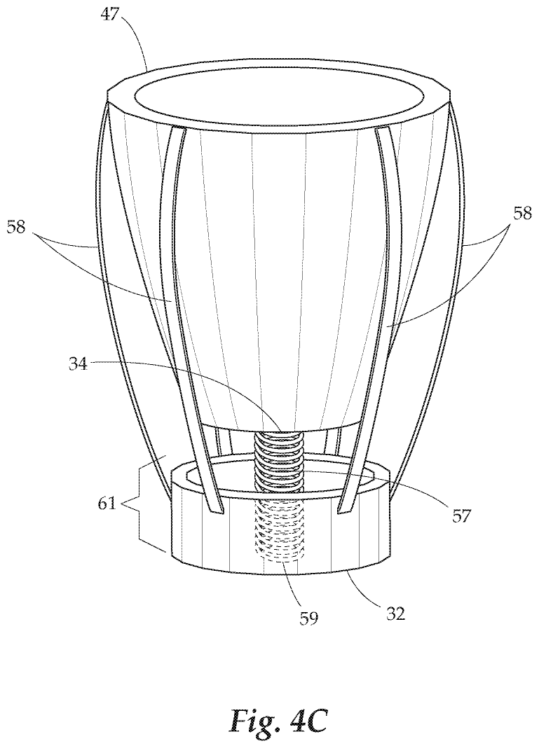

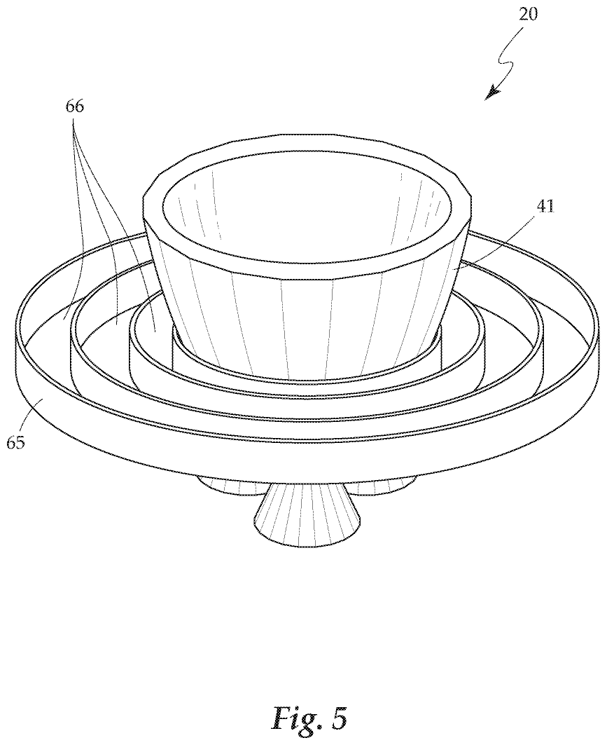

FIGS. 4A and 4B illustrate a perspective view of another alternate embodiment of the coffee pod correcting system 100. As shown in FIG. 4A, the top component 10 can further include a first outer rim 47 attached to an outside of the first distal end 40. For example, the first outer rim 47 can be an outer edge of the top thick rim 55. The first outer rim 47 can comprise a concave interior thread 54. Additionally, as shown in FIG. 4B, the base 20 can further include a second outer rim 51 attached to an outside of the second distal end 46. For example, the second outer rim 51 can be an outer edge of the bottom thick rim 45. The second outer rim 51 can comprise a convex interior thread 53. The convex interior thread 53 of the base 20 can be configured to receive the concave interior thread 54 of the top component 10 such that the top component 10 and the base 20 can be secured together.

FIG. 4C illustrates a perspective view of an additional embodiment of the top component 10. The additional embodiment illustrated in FIG. 4C can be used in conjunction with the embodiment illustrated in FIGS. 4A and 4B. In the additional embodiment shown in FIG. 4C, the top component 10 can further comprise a spring 57 and a plurality of elastic arms 58. The plurality of elastic arms 58 are fastened to the first outer rim 47 of the top component 10 and an outside area 61 of the knob 32. The spring 57 is affixed to a bottom 59 of the knob 32 and the top center area 34 of the top component 10. When the knob 32 is wound and released, the top component 10 freely spins on and over the bottom thick rim 45 of the base 20 with the edged rim 62 of the commercial coffee pod 52 wedged in between and resulting in the flattening of the rimmed edge 62.

FIG. 5 illustrates a perspective view of an additional embodiment of the base 20. In the additional embodiment, the coffee pod correcting system 100 includes a storage tray 65 that attaches to the base 20. The storage tray 65 is fastened around the second body 41 of the base 20 and houses a plurality of cup rings 66. Each cup ring of the plurality of cup rings 66 is sized to accommodate an individual corrected commercial coffee pod. As a result, after bent, dented, and/or warped coffee pods are corrected by utilizing the coffee pod correcting system 100 to flatten the rim of the pods, the pods can be placed in the plurality of cup rings 66 in the storage tray 65 to protect the pods from being re-bent and to store them in an accessible area that increases ease of usage.

It should be understood that various alternatives to the embodiments of the disclosure described herein may be employed in practicing the disclosure. Elements of an implementation of the apparatus described herein may be independently implemented or combined with other implementations.

What is claimed is:

1. A coffee pod correcting system comprising:
a top component further comprising:
a first concave cavity within a first body;
a first distal end; and
a top thick rim around the first distal end; and
a base further comprising:
a plurality of legs having a plurality of bottoms;
a second concave cavity within a second body;
a second distal end; and
a bottom thick rim around the second distal end.

2. The coffee pod correcting system of claim 1 wherein the first concave cavity within the first body is as deep as one half of the depth of a commercial coffee pod.

3. The coffee pod correcting system of claim 1 wherein the second concave cavity within the second body is as deep as one half of the depth of a commercial coffee pod.

4. The coffee pod correcting system of claim 1 wherein the first concave cavity within the first body is as wide as the width of a commercial coffee pod.

5. The coffee pod correcting system of claim 1 wherein the second concave cavity within the second body is as wide as the width of a commercial coffee pod.

6. The coffee pod correcting system of claim 1 wherein the bottom thick rim and the top thick rim are as wide as the width of an edged rim of a commercial coffee pod.

7. The coffee pod correcting system of claim 1 wherein the top component further comprises a knob.

8. The coffee pod correcting system of claim 1 wherein the top component further comprises a handle.

9. The coffee pod correcting system of claim 1 wherein the base further comprises a storage tray fastened around the second body of the base and housing a plurality of cup rings, each of the plurality of cup rings sized to accommodate an individual corrected commercial coffee pod.

10. The coffee pod correcting system of claim 1 wherein the second body of the base and the first body of the top component are cone shaped, providing more surface area for a user's hands to grasp the coffee pod correcting system during use.

11. The coffee pod correcting system of claim 1 wherein the second body of the base and the first body of the top component are hockey-puck shaped, providing less surface area and increasing portability.

12. The coffee pod correcting system of claim 1 wherein the plurality of bottoms of the plurality of legs further comprise a plurality of suction cups to stabilize the base when the coffee pod correcting system is in use.

13. The coffee pod correcting system of claim 1 wherein the plurality of bottoms of the plurality of legs further comprise a plurality of grip pads to stabilize the base when the coffee pod correcting system is in use.

14. The coffee pod correcting system of claim 1 wherein the top component further comprises a first outer rim attached to an outside of the first distal end, and the base further comprises a second outer rim attached to an outside of the second distal end.

15. The coffee pod correcting system of claim 14 wherein the second outer rim further comprises a convex interior thread configured to receive a concave interior thread of the first outer rim of the top component.

16. The coffee pod correcting system of claim 14 wherein the top component further comprises a spring, a plurality of elastic arms, and a knob, wherein the plurality of elastic arms are fastened to the first outer rim of the top component and an outside area of the knob, and wherein the spring is affixed to a bottom of the knob and a top center area of the top component.

17. A method for correcting a coffee pod comprising the steps of:
separating a base from a top component;
inserting a coffee pod in a second cavity of the base;
placing the top component over the coffee pod and onto the base;
stabilizing the base;
twisting the top component against the base laterally and in a clock-wise direction; and
twisting the top component against the base laterally and in a counter clock-wise direction.

18. The method for correcting a coffee pod of claim 17 further comprising the step of applying pressure to the top component against the base before twisting the top component against the base laterally and in a clock-wise direction.

19. A method for correcting a coffee pod comprising the steps of:
separating a base from a top component;
inserting a coffee pod in a second cavity of the base;
placing the top component over the coffee pod and onto the base;
grasping the base in a first hand of a user;
grasping the top component in a second hand of a user;
twisting the top component against the base laterally and in a clock-wise direction; and
twisting the top component against the base laterally and in a counter clock-wise direction.

20. The method for correcting a coffee pod of claim 19 further comprising the step of applying pressure to the top component against the base before twisting the top component against the base laterally and in a clock-wise direction.
